(19) United States
(12) Patent Application Publication
(10) Pub. No.: US 2019/0375909 A1
(43) Pub. Date: Dec. 12, 2019

(54) FOAMED ADHESIVE, MORE PARTICULARLY PRESSURE-SENSITIVE ADHESIVE, PROCESS FOR THE PRODUCTION AND ALSO THE USE THEREOF

(71) Applicant: tesa SE, Norderstedt (DE)

(72) Inventors: Franziska CZERWONATIS, Hamburg (DE); Axel BURMEISTER, Buchholz (DE); Sabine BHANDARI, Hamburg (DE); Christian KREFT, Hamburg (DE); Stephan BÜNZ, Ostrohe (DE)

(73) Assignee: tesa SE, Norderstedt (DE)

(21) Appl. No.: 16/527,936

(22) Filed: Jul. 31, 2019

Related U.S. Application Data
(63) Continuation of application No. 14/954,289, filed on Nov. 30, 2015.
Application No. 14/954,289 is a division of application No. 12/031,300, filed on Feb. 14, 2008, now abandoned.

(30) Foreign Application Priority Data
Jan. 14, 2008 (DE) 10 2008 004 388.5

(51) Int. Cl. C08J 9/32; B29C 70/66; C09J 153/02; C09J 107/00; C09J 133/10

(52) U.S. Cl. CPC C08J 9/32; B29C 70/66; C09J 153/02; B29K 2105/165; C09J 133/10; Y10T 428/2839; Y10T 428/28; C09J 107/00

(57) ABSTRACT

Process for producing a pressure-sensitive adhesive comprising expanded microballoons, wherein the constituents for forming the adhesive are mixed in a first mixing assembly, the mixed adhesive is transferred into a second mixing assembly into which, at the same time, unexpanded microballoons are fed, the microballoons are expanded in the second mixing assembly or on exit from the second mixing assembly, the adhesive mixture with the expanded microballoons is shaped to a layer in a shaping assembly in which expanded microballoons which have broken through the surface are pressed into the layer surface and the layer of adhesive mixture together with the expanded microballoons are optionally applied to a weblike backing material.

This application is a continuation of U.S. patent application Ser. No. 14/954,289, filed Nov. 30, 2015, which is a divisional of U.S. patent application Ser. No. 12/031,300, filed Feb. 14, 2008, now abandoned, which claims foreign priority benefit under 35 U.S.C. § 119 of German Patent Application No. 10 2008 004 388.5, filed Jan. 14, 2008, the disclosures of each of which are incorporated herein by reference.

The invention describes an adhesive, more particularly a pressure-sensitive adhesive, which is foamed with expanded polymeric hollow microbeads, known as microballoons, processes for producing it, and its use more particularly in an adhesive tape.

### BACKGROUND OF THE INVENTION

Microballoon-foamed (self-)adhesives have been described and known for a long time. They are distinguished by a defined cell structure with a uniform distribution of foam cell sizes. They are closed-cell microfoams without cavities, as a result of which they are able to seal sensitive goods more effectively against dust and liquid media in comparison to open-cell versions.

As a result of their flexible, thermoplastic polymer shell, such foams possess greater conformity than foams filled with unexpandable, non-polymeric hollow microbeads (hollow glass beads). They are better suited to the compensation of manufacturing tolerances of the kind which are the rule, for example, with injection mouldings, and on account of their foam character are also better able to compensate thermal stresses.

Furthermore, the mechanical properties of the foam can be influenced further by the selection of the thermoplastic resin of the polymer shell. Thus, for example, it is possible to produce foams having a higher cohesive strength than with the polymer matrix alone, even when the density of the foam is lower than that of the matrix. In this way it is possible for typical foam properties such as the conformability to rough substrates to be combined with a high cohesive strength for PSA foams.

Conventionally chemically or physically foamed materials, in contrast, are more susceptible to irreversible collapse under pressure and temperature. The cohesive strength is lower in such cases, too.

DE 21 05 877 C displays an adhesive tape composed of a backing which is coated on at least one side with a microcellular pressure-sensitive adhesive and whose adhesive layer comprises a nucleating agent, the cells of the adhesive layer being closed and being distributed completely in the adhesive layer. This adhesive tape has the ability to conform to the irregular surface to which it is applied and hence may lead to a relatively durable adhesive bond, yet on the other hand exhibits only minimal recovery when compressed to half its original thickness. The voids in the adhesive offer starting points for the entry of solvents and water into the glueline from the side, which is highly undesirable. Furthermore, it is impossible to rule out the complete penetration of solvents or water through the entire adhesive tape.

EP 0 257 984 A1 discloses adhesive tapes which at least on one side have a foamed adhesive coating. Contained within this adhesive coating are small polymer beads which in turn contain a liquid composed of hydrocarbons, and expand at elevated temperatures. The backbone polymers of the self-adhesives may be composed of rubbers or polyacrylates. The hollow microbeads are here added either before or after the polymerization. The self-adhesives comprising microballoons are processed from solvent and shaped to form adhesive tapes. The step of foaming in this case, consequently, takes place after coating. In this way microrough surfaces are obtained. This results in properties such as, more particularly, non-destructive redetachability and repositionability. The effect of improved repositionability as a result of microrough surfaces of self-adhesives foamed with microballoons is also described in further specifications such as DE 35 37 433 A1 or WO 95/31225 A1.

The microrough surface is used to generate a bubble-free adhesive bond. This use is also disclosed by EP 0 693 097 A1 and WO 98/18878 A1.

The advantageous properties of the microrough surface, however, are always countered by a marked reduction in the bond strength and/or the peel strength. Accordingly DE 197 30 854 A1 proposes a backing layer which is foamed with microballoons and which in order to avoid the loss of bond strength proposes the use of unfoamed pressure-sensitive self-adhesives above and below a foamed core.

The backing mixture is preferably prepared in an internal mixer typical for elastomer compounding. This mixture is adjusted more particularly to a Mooney value ML₁₊₃ (100° C.) in the range from 10 to 80. In a second, cold operation, possible crosslinkers, accelerators and the desired microballoons are added to the mixture. This second operation takes place preferably at temperatures less than 70° C. in a kneader, internal mixer, mixing roll mill or twin-screw extruder. The mixture is subsequently extruded and/or calendered to the desired thickness on machines. Subsequently the backing is provided on both sides with a pressure-sensitive self-adhesive. This is followed by the steps of thermal foaming and, where appropriate, crosslinking.

The microballoons can in this case be expanded either before their incorporation into the polymer matrix or not until after shaping of the polymer matrix to form a backing.

In expanded form the casing of the microballoons has a thickness of only 0.02 μm. Accordingly, the proposed expansion of the microballoons prior to incorporation into the polymer matrix of the backing material is disadvantageous, since in that case, as a result of the high forces during incorporation, many balloons will be destroyed and the degree of foaming, accordingly, will be reduced. Furthermore, partly damaged microballoons lead to fluctuations in thickness. A robust production operation is barely achievable.

Preference is given, accordingly, to carrying out foaming after the weblike shaping in a thermal tunnel. In this case too, however, substantial deviations of the average carrier thickness from the desired thickness are a likely occurrence, owing to a lack of precisely constant conditions in the overall operation prior to foaming, and to a lack of precisely constant conditions in the thermal tunnel during foaming. Specific correction to the thickness is no longer possible. Similarly, considerable statistical deviations in thickness must be accepted, since local deviations in the concentration of microballoons and of other backing constituents are manifested directly in fluctuations in thickness.

A similar route is described by WO 95/32851 A1. There it is proposed that additional thermoplastic layers be provided between foamed backing and self-adhesive.

Both routes do comply with the requirement of high peel strength, but also lead automatically to products having a relatively high susceptibility, since the individual layers lead to anchoring breaks under load. Furthermore, the desired conformability of such products is significantly restricted, because the foamed component of a construction is automatically reduced.

EP 1 102 809 A1 proposes a process in which the microballoons undergo partial expansion prior to exit from a coating die and, where appropriate, are brought to complete expansion by means of a downstream step.

This process leads to products having a much lower surface roughness and, associated therewith, a smaller drop in peel strength. In terms of its function with respect to the viscosity of the material, however, it is greatly limited. Highly viscous systems of material lead inevitably to a high nip pressure in the nozzle nip, which compresses or deforms the expanded microballoons. Following exit from the die, the microballoons regain their original shape and puncture the surface of the adhesive. This effect is intensified by increasing viscosity of the material, decreasing layer thickness, and falling density or rising microballoon fraction.

It is an object of the present invention to remove the disadvantages of the existing processes for producing microballoon-foamed adhesives, namely the disadvantages of the rough surfaces and the resulting low bond strengths even at low densities and/or high foaming rates, or the need for an additional aftercoat material in the case of a foamed backing.

This object is achieved by means of a process for producing a preferably pressure-sensitive adhesive which comprises expanded microballoons, as set out in the main claim. The dependent claims provide advantageous embodiments of the subject matter of the invention, and also the use of the adhesive produced in accordance with the invention in single-sided or double-sided adhesive tapes.

### SUMMARY OF THE INVENTION

The invention accordingly provides an adhesive, more particularly pressure-sensitive adhesive, which comprises expanded microballoons, the bond strength of the adhesive comprising the expanded microballoons being reduced by not more than 30%, preferably not more than 20%, more preferably 10%, in comparison to the bond strength of an adhesive of identical coatweight and formula which has been defoamed by the destruction of the voids produced by the expanded microballoons.

### DETAILED DESCRIPTION

According to one preferred embodiment of the invention the bond strength of the adhesive comprising the expanded microballoons is not reduced in comparison to the bond strength of an adhesive of identical coatweight and formula which has been defoamed by the destruction of the voids produced by the expanded microballoons.

With further preference the bond strength of the adhesive comprising the expanded microballoons is higher, preferably by 10% to 30%, in comparison to the bond strength of an adhesive of identical coatweight and formula which has been defoamed by the destruction of the voids produced by the expanded microballoons.

According to another advantageous embodiment the adhesive has a surface roughness of less than or equal to 10 μm.

Furthermore, the invention encompasses a process for producing an adhesive, also preferably a pressure-sensitive adhesive, which comprises expanded microballoons—see FIG. 3—wherein
the constituents for forming the adhesive such as polymers, resins or fillers are mixed with unexpanded microballoons in a first mixing assembly and are heated to expansion temperature under superatmospheric pressure,
the microballoons are expanded on exit from the mixing assembly,
the adhesive mixture together with the expanded microballoons is shaped to a layer in a roll applicator,
the adhesive mixture together with the expanded microballoons is applied where appropriate to a weblike backing material or release material.

The invention also encompasses a process for producing an adhesive, again preferably a pressure-sensitive adhesive, which comprises expanded microballoons—see FIG. 2—wherein
the constituents for forming the adhesive such as polymers, resins or fillers are mixed with unexpanded microballoons in a first mixing assembly under superatmospheric pressure and are heated to a temperature below the expansion temperature of the microballoons,
the mixed, more particularly homogeneous, adhesive from the first mixing assembly is transferred to a second assembly and heated to expansion temperature under superatmospheric pressure,
the microballoons are expanded in the second assembly or on exit from the mixing assembly,
the adhesive mixture together with the expanded microballoons is shaped to a layer in a roll applicator,
the adhesive mixture together with the expanded microballoons is applied where appropriate to a weblike backing material or release material.

The invention also provides a process for producing an adhesive, in turn preferably a pressure-sensitive adhesive, which comprises expanded microballoons—see FIG. 1—wherein
the constituents for forming the adhesive such as polymers, resins or fillers are mixed in a first mixing assembly,
the mixed, more particularly homogenous, adhesive from the first mixing assembly is transferred into a second mixing assembly, into which, at the same time, the unexpanded microballoons are fed,
the microballoons are expanded in the second mixing assembly or on exit from the second mixing assembly,
the adhesive mixture together with the expanded microballoons is shaped to a layer in a roll applicator,
the adhesive mixture together with the expanded microballoons is applied where appropriate to a weblike backing material or release material.

According to one preferred embodiment of the invention the adhesive is shaped in a roll applicator and applied to the backing material.

Microballoon-foamed compositions need not generally be degassed prior to coating in order to give a uniform, coherent coating pattern. The expanding microballoons displace the air which is enclosed in the adhesive in the course of compounding. In the case of high throughputs it is nevertheless advisable to degas the compositions prior to coating in order to obtain a uniform charge of composition in the roll nip. Degassing takes place ideally immediately upstream of the roll applicator at mixing temperature and under a differential pressure, relative to the ambient pressure, of at least 200 mbar.

Additionally it is advantageous if
the first mixing assembly is a continuous assembly, more particularly a planetary roller extruder, a twin-screw extruder or a pin extruder,
the first mixing assembly is a discontinuous assembly, more particularly a Z-type kneader or an internal mixer,
the second mixing assembly is a planetary roller extruder, a single-screw or twin-screw extruder or a pin extruder and/or
the shaping assembly in which the adhesive together with the expanded microballoons is shaped to a backing layer is a calender, a roll applicator or a nip formed by a roll and a stationary doctor blade.

With the processes of the invention it is possible to carry out solventless processing of all existing and literature-described components of adhesives, more particularly self-adhesive versions.

In the text below, the processes described above and situated within the concept of the invention are illustrated in particularly outstanding variant embodiments, without wishing any unnecessary restriction to result from the choice of figures depicted.

### BRIEF DESCRIPTION OF THE DRAWINGS

In the figures

FIG. 1 shows the process with two mixing assemblies, the microballoons being added only in the second mixing assembly,

FIG. 2 shows the process with two mixing assemblies, the microballoons being added in the first mixing assembly; and

FIG. 3 shows the process with one mixing assembly, the microballoons being added directly in the first mixing assembly.

FIG. 4 shows the bond areas as a function of the coating process and coating parameters.

FIG. 5. shows the construction of a self-adhesive tape foamed with microballoons and consisting of an adhesive containing the microballoons on a woven fabric backing.

FIG. 6 shows the construction of an adhesive 62, foamed with microballoons 63, which has been applied to a liner 61.

FIG. 7. shows an adhesive having a microballoon content of 8% by weight. leading to a density for the adhesive of 338 kg/m³.

FIG. 8 shows an adhesive having a microballoon content of 22% by weight and a density of 137 kg/m³.

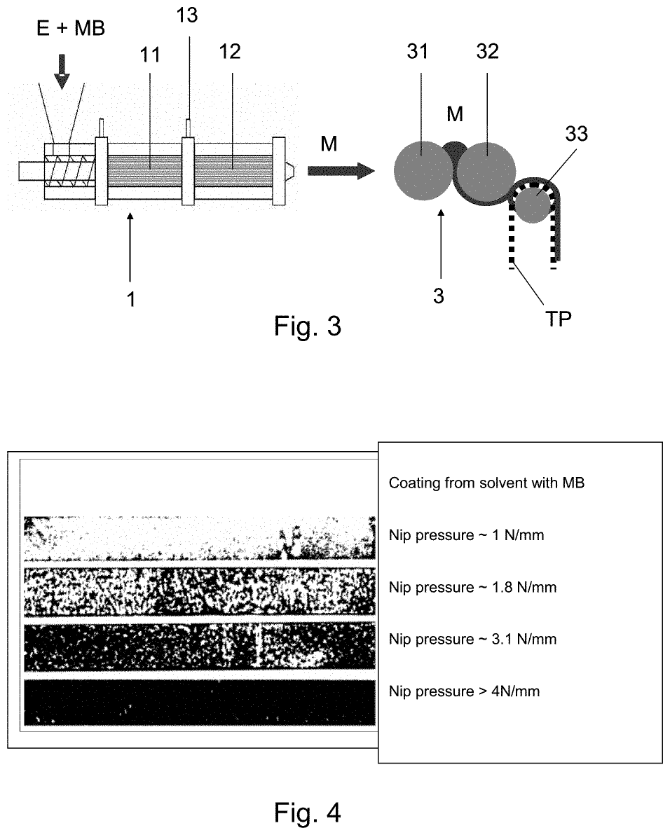

FIG. 3 shows one particularly advantageously embodied process for producing a foamed pressure-sensitive self-adhesive tape.

A (self-)adhesive is produced in a continuous mixing assembly such as, for example, a planetary roller extruder (PWE).

For this purpose the starting materials E intended to form the adhesive are fed to the planetary roll extruder 1. At the same time the unexpanded microballoons MB are incorporated into the self-adhesive during the compounding operation, homogeneously and under superatmospheric pressure.

The required temperatures for the homogeneous production of the self-adhesive and for the expansion of the microballoons are harmonized with one another in such a way that, on exit from the die of the planetary roll extruder 1, as a result of the drop in pressure, the microballoons foam up in the self-adhesive M and, in so doing, break through the surface of the composition.

With a roll applicator 3 as shaping assembly, this foamlike adhesive M is calendered and coated onto a weblike backing material such as, for example, release paper TP; in some cases there may also be subsequent foaming in the roll nip. The roll applicator 3 is composed of a doctor blade roll 31 and a coating roll 32. The release paper TP is guided to the latter roll via a pick-up roll 33, so that the release paper TP takes the foamlike adhesive M from the coating roll 32.

At the same time the expanded microballoons MB are pressed again into the polymer matrix of the foamlike adhesive M, thereby producing a smooth and permanently (irreversibly) adhesive surface in conjunction with very low densities of up to 150 kg/m³.

FIG. 2 shows a further particularly advantageously embodied process for producing a foamed pressure-sensitive self-adhesive tape.

The planetary roller extruder 1 has two mixing zones 11 and 12 which are in series and in which there rotates a central spindle. Additionally there are six planetary spindles present per heating zone. Further starting materials are added in the injection ring 13, such as plasticizer or liquid resin, for example.

One suitable apparatus is, for example, the planetary roller extruder from the company Entex at Bochum.

Subsequently the microballoons, in a second mixing assembly such as a single-screw extruder, for example, are incorporated homogeneously into the self-adhesive under superatmospheric pressure, and are heated above the expansion temperature and foamed on exit.

For this purpose the adhesive K formed from the starting materials E and the unexpanded microballoons are fed here into the single-screw extruder ESE 2. Over its running length 21, the single-screw extruder ESE 2 has a total of four heating zones.

One suitable apparatus is, for example, a single-screw extruder from the company Kiener.

During the expansion, caused by drop in pressure, at the exit from the die of the single-screw extruder ESE 2, the microballoons MB break through the surface of the composition.

With a roll applicator 3 as a shaping assembly, this foamlike adhesive M is calendered and coated onto a weblike backing material such as, for example, release paper TP; in some cases there may also be subsequent foaming in the roll nip. The roll applicator 3 is composed of a doctor blade roll 31 and a coating roll 32. The release paper TP is guided to the latter roll via a pick-up roll 33, so that the release paper TP takes the foamlike adhesive M from the coating roll 32.

At the same time the expanded microballoons MB are pressed again into the polymer matrix of the foamlike adhesive M, thereby producing a smooth and permanently (irreversibly) adhesive surface in conjunction with very low densities of up to 150 kg/m³.

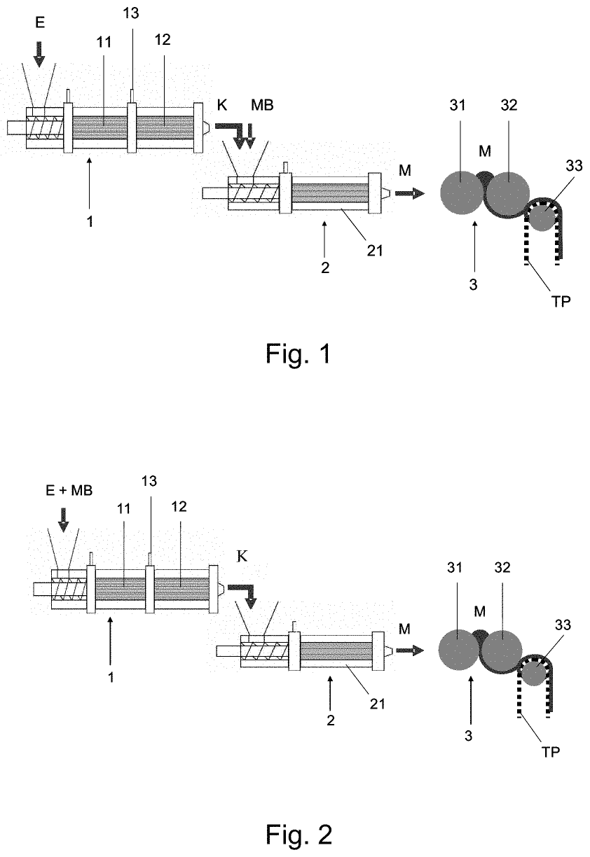

FIG. 1 shows a further particularly advantageously embodied process for producing a foamed pressure-sensitive self-adhesive tape.

A (self-)adhesive is produced in a continuous mixing assembly such as, for example, a planetary roller extruder (PWE).

Here the starting materials E which are intended to form the adhesive are fed to the planetary roller extruder 1. The planetary roller extruder 1 has two mixing zones 11 and 12 which are in series and in which there rotates a central spindle. Additionally there are six planetary spindles present per heating zone. Further starting materials are added in the injection ring 13, such as plasticizer or liquid resin, for example.

One suitable apparatus is, for example, the planetary roller extruder from the company Entex at Bochum.

Subsequently the microballoons, in a second mixing assembly such as a single-screw extruder, for example, are incorporated homogeneously into the self-adhesive under superatmospheric pressure, and are heated above the expansion temperature and foamed on exit.

For this purpose the adhesive K formed from the starting materials E is fed here into the single-screw extruder 2, and at the same time the microballoons MB are introduced. Over its running length 21, the single-screw extruder 2 has a total of four heating zones.

One suitable apparatus is, for example, a single-screw extruder from the company Kiener.

During the expansion, caused by drop in pressure, at the exit from the die of the single-screw extruder 2, the microballoons MB break through the surface of the composition.

With a roll applicator as shaping assembly 3, this foamlike adhesive M is calendered and coated onto a weblike backing material such as, for example, release paper TP; in some cases there may also be subsequent foaming in the roll nip. The roll applicator 3 is composed of a doctor blade roll 31 and a coating roll 32. The release paper TP is guided to the latter roll via a pick-up roll 33, so that the release paper TP takes the foamlike adhesive M from the coating roll 32.

At the same time the expanded microballoons MB are pressed again into the polymer matrix of the foamlike adhesive M, thereby producing a smooth and permanently (irreversibly) adhesive surface in conjunction with very low densities of up to 150 kg/m³.

As the nip pressure in the roll nip falls there is a reduction in the bond areas of the coated, foamed self-adhesives, since in that case the microballoons are pressed back less strongly, as can be seen from FIG. 4. FIG. 4 shows the bond areas as a function of the coating process and coating parameters. The nip pressure required is heavily dependent on the composition system used: the higher the viscosity, the greater should be the nip pressure, depending on the desired layer thickness and on the chosen coating speed. In practice a nip pressure of greater than 4 N/mm has been found to be appropriate, or, at particularly high coating speeds, greater than 50 m/min; in the case of low levels of application of composition (coatweights less than 70 g/m²) and highly viscous compositions (50 000 Pa*s at 0.1 rad and 110° C.) it is also possible for nip pressures greater than 50 N/mm to be required.

It has been found to be appropriate to adapt the temperature of the rolls to the expansion temperature of the microballoons. Ideally the roll temperature of the first rolls lies above the expansion temperature of the microballoons, in order to allow afterfoaming of the microballoons without their destruction. The last roll ought to have a temperature equal to or below the expansion temperature, so that the microballoon casing can solidify and so that the smooth surface according to the invention is formed.

There are many known assemblies for the continuous production and processing of solvent-free polymer systems. Most usually used are screw machines such as single-screw and twin-screw extruders in a wide variety of barrel lengths and with a wide variety of internals. Use is also made, however, of continuous kneaders of a wide variety of constructions, including, for example, combinations of kneaders and screw machines, or else planetary roller extruders, for this function.

Planetary roller extruders have been known for a fairly long time and were first used in the processing of thermoplastics such as PVC, for example, where they were used primarily to supply the downstream units such as calenders or roll mills, for example. As a consequence of their advantage of the great renewal of surface area for material exchange and heat exchange, allowing the frictional energy to be removed rapidly and effectively, and because of the low residence time and the narrow residence-time spectrum, their use in recent times has been extended to—among other operations—compounding operations which require a particularly temperature-controlled regime.

Depending on manufacturer, planetary roller extruders are available in different designs and sizes. The diameters of the roller cylinders, depending on the desired throughput, are typically between 70 mm and 400 mm.

Planetary roller extruders generally have a filling section and a compounding section.

The filling section is composed of a conveying screw to which all of the solid components are fed continuously. The conveying screw then transfers the material to the compounding section. The area of the filling section, together with the screw, is preferably cooled in order to prevent materials becoming baked onto the screw. Alternatively there are embodiments without a screw section, where the material is fed directly between central spindle and planetary spindles. However, this is not important for the effectiveness of the process of the invention.

The compounding section is composed of a driven central spindle and a plurality of planetary spindles which rotate around the central spindle within one or more roller cylinders with internal helical gearing. The rotary speed of the central spindle and hence the rotational speed of the planetary spindles can be varied and is therefore an important parameter for the control of the compounding operation.

The materials are circulated between the central and planetary spindles, or between planetary spindles and the helical gearing of the roller section, so that, under the influence of shearing energy and external heating, the materials are dispersed to form a homogeneous compound.

The number of planetary spindles rotating in each roller cylinder can be varied and thus adapted to the requirements of the operation. The number of spindles influences the free volume within the planetary roller extruder, and the residence time of the material in the process, and also determines the size of surface for heat exchange and material exchange. By way of the shearing energy introduced, the number of planetary spindles has an influence on the compounding outcome. Given a constant diameter of roller cylinder, a larger number of spindles permits better homogenization and dispersion or, respectively, a greater product throughput.

The maximum number of planetary spindles installable between the central spindle and the roller cylinder is dependent on the diameter of the roller cylinder and on the diameter of the planetary spindles used. When using relatively large roller diameters, of the kind needed for obtaining production-scale throughput rates, and/or relatively small diameters for the planetary spindles, the roller cylinders can be equipped with a relatively large number of planetary spindles. Typically, in the case of a roller diameter of D=70 mm, up to seven planetary spindles are used, whereas with a roller diameter of D=200 mm it is possible to use, for example, ten planetary spindles, and in the case of a roller diameter of D=400 mm 24 planetary spindles, for example, can be used.

In accordance with the invention it is proposed that the coating of the foamed adhesives be carried out solventlessly using a multi-roll applicator. These may be applicators consisting of at least two rolls having at least one roll nip, up to five rolls having three roll nips.

Also suitable are coating mechanisms such as calenders (I,F and L calenders), so that the foamed adhesive is shaped to the desired thickness as it passes through one or more roll nips.

It has proved to be particularly advantageous in this context to select the temperature regime for the individual rolls in such a way that, where appropriate, controlled afterfoaming can take place, such that rolls with a transfer function can have a temperature equal to or above the foaming temperature of the type of microballoons selected, while rolls with a receiving function ought to have a temperature equal to or below the foaming temperature, in order to prevent uncontrolled foaming, with all of the rolls being individually adjustable to temperatures of 30 to 220° C.

In order to improve the transfer characteristics of the shaped layer of composition from one roll to another it is also possible for anti-adhesively treated rolls or patterned rolls to be employed. In order to be able to produce a sufficiently precisely shaped film of adhesive, there may be differences in the peripheral speeds of the rolls.

The preferred 4-roll applicator is formed by a metering roll, a doctorblade roll, which determines the thickness of the layer on the backing material and is arranged parallel to the metering roll, and a transfer roll, which is located beneath the metering roll. At the lay-on roll, which together with the transfer roll forms a second roll nip, the composition and the weblike material are brought together.

Depending on the nature of the weblike carrier material for coating, coating may take place in a co-rotational or counter-rotational process.

The shaping assembly may also be formed by a gap which is produced between a roll and a fixed doctor. The fixed doctor may be a knife-type doctor or else a stationary (half-)roll.

With the processes described in accordance with the invention it is possible to produce self-adhesive products which on the one hand combine the advantages of a microballoon-foamed self-adhesive composition but on the other hand do not exhibit the typical drop in bond strength in relation to the unfoamed product. Entirely surprisingly and unforeseeably for the person skilled in the art, it is also possible with this process to produce self-adhesive products when the layer thickness of the foamed self-adhesive is situated in the region of the diameter of the expanded microballoons. It is also surprising that it is possible to produce products with such a low density that, governed by the diameter of the microballoons, the theoretically closest spherical packing is exceeded.

In a theoretically closest spherical packing, each sphere has twelve immediate neighbours: six in its own layer and three each above and below. In the case of cubic packing they form a cube octahedron; in the case of hexagonal packing they form an anti-cube octahedron.

The degree of space filling of a theoretically closest spherical packing is

$$\frac{Π}{3 \sqrt{2}} \approx 0.74048 \approx 74 \%$$

Since in the case of a higher degree of filling the microballoons in the adhesive are present not in the form of spheres, but are instead irreversibly deformed to give three-dimensional polyhedra, it is possible for the degree of space filling of the expanded microballoons in the adhesive to be above 74%.

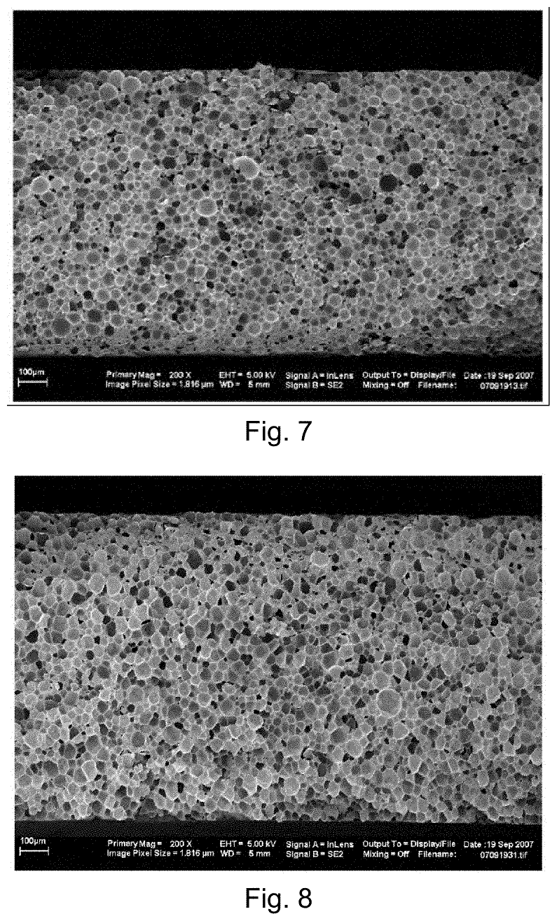

This is shown very illustratively by FIGS. 7 and 8. FIG. 7 shows an adhesive having a microballoon content of 8% by weight, leading to a density for the adhesive of 338 kg/m³. FIG. 8 shows an adhesive having a microballoon content of 22% by weight and a density of 137 kg/m³.

As is clearly shown, on the basis of the readily apparent deformation of the expanded microballoons, the degree of filling is above the theoretically closest possible spherical packing. The microballoons have a polyhedral form and are no longer spherical.

The novelty of the processes of the invention and hence also of the adhesive lies in the fact that, during shaping to a layer, more particularly immediately prior to the coating operation, the expanded microballoons are pressed into the polymer matrix of the adhesive, and hence a smooth, permanently adhesive surface of the composition is shaped by means of the shaping assembly, more particularly the roll applicator.

It is possible to produce foamed, strongly adhesive self-adhesive tapes in a layer-thickness range from 20 to 3000 μm with high microballoon contents and hence high foaming rates or low densities.

The utility of foamed adhesive lies on the one hand in cost reduction. It is possible to save on raw materials, since, for identical layer thicknesses, coatweights can be reduced by a multiple. In addition, for identical throughput or production of adhesive quantities, the coating speeds can be increased.

Furthermore, the foaming of the adhesive gives rise to improved technical and performance properties.

This lowering of the drop in bond strength is promoted by the high surface quality generated by the pressing-back of the expanded microballoons into the polymer matrix during the coating operation.

Furthermore, the foamed self-adhesive gains additional performance features as compared with the unfoamed composition with the same polymer basis, such features including, for example, an improved shock resistance at low temperatures, increased bond strength on rough substrates, greater damping and/or sealing properties or conformability of the foam adhesive to uneven substrates, a more favourable compression/hardness behaviour, and improved compression capacity.

Some further elucidation of the characteristic properites and additional functions of the self-adhesives of the invention occurs in the examples.

A foamed adhesive from the preferred hotmelt adhesive has a smooth adhesive surface, since in the course of coating, in the roll nip, the expanded microballoons are subsequently pressed again into the polymer matrix, and consequently it has a preferred surface roughness Rₐ of less than 10 μm. The determination of surface roughness is suitable only for adhesive tapes which are based on a very smooth backing and themselves have only a surface roughness Rₐ of less than 1 μm. In the case of backings relevant to practice, such as creped papers or nonwovens and woven fabrics, for example, with a greater surface roughness, accordingly, the determination of the product's surface roughness is not suitable for describing the process advantages.

According to one preferred embodiment of the invention the fraction of the microballoons in the adhesive is between greater than 0% and 30% by weight, more particularly between 1.5% and 10% by weight.

With further preference the microballoons have a diameter at 25° C. of 3 μm to 40 μm, more particularly 5 μm to 20 μm, and/or a diameter after temperature exposure of 20 μm to 200 μm, more particularly 40 μm to 100 μm.

In all of the processes known to date for the production of microballoon-foamed adhesive systems, the resulting surface of the adhesive is rough with little or no tack.

Starting from a microballoon content as low as 0.5% by weight, it is possible to obtain bond strength (peel strength) losses of greater than 40% in the case of a self-adhesive coated from solvent. As the microballoon content increases, the bond strengths fall further and the cohesion goes up.

At a fraction of just 1% by weight of microballoons, the adhesion of the adhesive is already very low.

This is underlined by Comparative Examples 1.1 and 1.2 and by Table 3.

The ratio of the density of the adhesive foamed by the microballoons to the density of the adhesive of identical coatweight and formula defoamed by the destruction of the voids produced by the expanded microballoons is preferably less than 0.8.

This behaviour is also exhibited in the case of solvent-free nozzle coating, the microballoons foaming on pressure compensation after exit from the extruder/nozzle, and breaking through the adhesive matrix.

Also lying within the concept of the invention is an adhesive, more particularly a self-adhesive, obtained by the process of the invention.

Further embraced by the concept of the invention is a self-adhesive tape produced with the assistance of the adhesive, by applying the adhesive to at least one side of a weblike material. In a double-sided adhesive tape, both adhesive coatings may be inventive. An alternative provision is for only one of the two coatings to be inventive, while the second can be chosen arbitrarily (adapted to the functions the adhesive tape is to fulfill).

As backing material, preference is given to a film, a woven fabric or a paper to one side of which the (self-)adhesive is applied.

Furthermore, preferably, the (self-)adhesive is applied to a release paper or a release film, thus resulting in an unbacked adhesive tape, also referred to for short as a fixer.

The thickness of the adhesive in an adhesive tape on the weblike backing material may be between 20 μm and 3000 μm, preferably between 40 μm and 150 μm.

Furthermore, the adhesive may be applied in a thickness of 20 μm to 2000 μm to a release material if the layer of adhesive, more particularly after crosslinking, is to be used as an unbacked double-sided self-adhesive tape.

Microballoons are elastic hollow spheres which have a thermoplastic polymer casing. These spheres are filled with low-boiling liquids or with liquefied gas. Used as casing material are, more particularly, polyacrylonitrile, PVDC, PVC or polyacrylates. Suitable low-boiling liquids are more particularly hydrocarbons such as the lower alkanes, isobutane or isopentane for example, which are enclosed in the form of a liquefied gas under pressure in the polymer casing.

The exposing of the microballoons, more particularly their exposure to heat, has the effect on the one hand of softening the outer polymer casing. At the same time, the liquid propellant gas within the casing converts into its gaseous state. In this case the microballoons undergo irreversible extension and three-dimensional expansion. The expansion is at an end when the internal pressure and the external pressure compensate one another. Since the polymeric casing is retained, the result is a closed-cell foam.

A multiplicity of types of microballoon are available commercially, such as, for example, from the company Akzo Nobel, the Expancel DU products (dry unexpanded), which differ essentially in their size (6 to 45 μm in diameter in the unexpanded state) and in the initiation temperature they require for expansion (75 to 220° C.). When the type of microballoon or the foaming temperature has been harmonized with the temperature profile required for compounding the composition and with the machine parameters, it is also possible for compounding of the composition and foaming to take place in one step. Furthermore, unexpanded microballoon products are also available in the form of an aqueous dispersion having a solids content or microballoon content of approximately 40% to 45% by weight, and also, furthermore, as polymer-bound microballoons (masterbatches), for example in ethylene-vinyl acetate with a microballoon concentration of approximately 65% by weight. Not only the microballoon dispersions but also the masterbatches are suitable, like the DU products, for the foaming of adhesives in accordance with the process of the invention.

The selection of a suitable adhesive base for practicing the process of the invention is not critical. The said base can be selected from the group of thermoplastic elastomers containing natural rubbers and synthetic rubbers, including block copolymers and blends thereof, but also from the group referred to as polyacrylate adhesives.

The basis for the rubber-based adhesives is advantageously a non-thermoplastic elastomer selected from the group of the natural rubbers or the synthetic rubbers, or is composed of any desired blend of natural rubbers and/or synthetic rubbers, the natural rubber or natural rubbers being selectable in principle from all available grades such as, for example, crepe, RSS, ADS, TSR or CV products, depending on required purity and viscosity, and the synthetic rubber or synthetic rubbers being selectable from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

Furthermore, and preferably, it is possible to select thermoplastic elastomers as a basis for the adhesive.

As representatives mention may be made at this point of the styrene block copolymers and, especially, the styrene-isoprene-styrene (SIS) and styrene-butadiene-styrene (SBS) products.

Furthermore, and preferably, the adhesive can also be selected from the group of the polyacrylates.

As tackifying resins it is possible without exception to use all known tackifier resins which have been described in the literature. Representatives that may be mentioned include the rosins, their disproportionated, hydrogenated, polymerized and esterified derivatives and salts, the aliphatic and aromatic hydrocarbon resins, terpene resins and terpene-phenolic resins. Any desired combinations of these and other resins may be used in order to adjust the properties of the resulting adhesive in accordance with what is desired. Explicit reference may be made to the depiction of the state of the art in the “Handbook of Pressure Sensitive Adhesive Technology” by Donatas Satas (van Nostrand, 1989).

Plasticizers which can be used are all plasticizing substances known from adhesive tape technology. They include, among others, the paraffinic and naphthenic oils, (functionalized) oligomers such as oligobutadienes and oligoisoprenes, liquid nitrile rubbers, liquid terpene resins, animal and vegetable oils and fats, phthalates and functionalized acrylates.

For the purpose of thermally induced chemical crosslinking it is possible, for the process of the invention, to use all existing thermally activable chemical crosslinkers such as accelerated sulphur systems of sulphur donor systems, isocyanate systems, reactive melamine resins, formaldehyde resins and (optionally halogenated) phenol-formaldehyde resins and/or reactive phenolic-resin or diisocyanate crosslinking systems with the corresponding activators, or epoxidized polyester resins and acrylate resins, and also combinations thereof.

The crosslinkers are preferably activated at temperatures above 50° C., more particularly at temperatures from 100° C. to 160° C., with very particular preference at temperatures from 110° C. to 140° C.

The thermal excitation of the crosslinkers may also be accomplished by means of IR rays or high-energy alternating fields.

As backing material for the single-sided or double-sided adhesive tape it is possible to use all known textile backings such as a loop product or a velour, lay, woven fabric or knitted fabric, more particularly a woven PET filament fabric or a woven polyamide fabric, or a nonwoven web; the term “web” embraces at least textile fabrics according to EN 29092 (1988) and also stitchbonded nonwovens and similar systems.

It is likewise possible to use spacer fabrics, including wovens and knits, with lamination. Spacer fabrics are matlike layer structures having a cover layer composed of a fibre or filament fleece, an underlayer, and individual retaining fibres of bundles of such fibres between these layers, the said fibres being distributed over the area of the layer structure, being needled through the particle layer, and joining the cover layer and the underlayer to one another. The retaining fibres that are needled through the particle layer hold the cover layer and the underlayer at a distance from one another and are joined to the cover layer and the underlayer.

Suitable nonwovens include, in particular, consolidated staple fibre webs, but also filament webs, melt blown webs and spunbonded webs, which generally require additional consolidation. Known, possible consolidation methods for webs are mechanical, thermal and chemical consolidation. Whereas with mechanical consolidations the fibres are held together purely mechanically, usually by entanglement of the individual fibres, by the interleafing of fibre bundles or by the stitching-in of additional threads, it is possible by thermal and by chemical techniques to obtain adhesive (with binder) or cohesive (binderless) fibre-fibre bonds. Given appropriate formulation and an appropriate process regime, these bonds may be restricted exclusively, or at least predominantly, to the fibre nodal points, so that a stable, three-dimensional network is formed while retaining the loose, open structure in the web.

Webs which have proved to be particularly advantageous are those consolidated more particularly by overstitching with separate threads or by interlooping.

Consolidated webs of this kind are produced, for example, on stitchbonding machines of the “Malifleece” type from the company Karl Mayer, formerly Malimo, and can be obtained from companies including Naue Fasertechnik and Techtex GmbH. A Malifleece is characterized in that a cross-laid web is consolidated by the formation of loops from fibres of the web.

The backing used may also be a web of the Kunit or Multiknit type. A Kunit web is characterized in that it originates from the processing of a longitudinally oriented fibre web to produce a fabric which has loops on one side and on the other has loop feeds or pile fibre folds, but possesses neither threads nor prefabricated fabrics. A web of this kind as well has been produced for a relatively long time on, for example, stitchbonding machines of the “Kunitvlies” type from the company Karl Mayer. A further characterizing feature of this web is that, as a longitudinal fibre web, it is able to accommodate high tensile forces in the longitudinal direction. The characteristic feature of a Multiknit web relative to the Kunit web is that the web is consolidated on both the top and bottom sides by virtue of the double-sided needle punching.

Finally, stitchbonded webs are also suitable as an intermediate for forming an adhesive tape of the invention. A stitchbonded web is formed from a nonwoven material having a multiplicity of stitches extending parallel to one another. These stitches come about through the incorporation, by stitching or knitting, of continuous textile threads. For this type of web, stitchbonding machines of the “Maliwatt” type are known from the company Karl Mayer, formerly Malimo.

And then the Caliweb® is outstandingly suitable. The Caliweb® consists of a thermally fixed Multiknit spacer web with two outer mesh layers and an inner pile layer which is disposed perpendicular to the mesh layers.

Also particularly advantageous is a staple fibre web which is mechanically preconsolidated in the first step or is a wet-lay web laid hydrodynamically, in which between 2% and 50% of the web fibres are fusible fibres, more particularly between 5% and 40% of the fibres of the web.

A web of this kind is characterized in that the fibres are laid wet or, for example, a staple fibre web is preconsolidated by the formation of loops from fibres of the web or by needling, stitching or air-jet and/or water-jet treatment.

In a second step, thermofixing takes place, with the strength of the web being increased again by the melting-on or partial melting of the fusible fibres.

The web backing may also be consolidated without binders, by means, for example, of hot embossing with structured rollers, in which case pressure, temperature, dwell time and the embossing geometry can be used to control properties such as strength, thickness, density, flexibility and the like.

Starting materials envisaged for the textile backings include, more particularly, polyester fibres, polypropylene fibres, viscose fibres or cotton fibres. The present invention, though, is not restricted to the materials stated; instead it is possible to use a multiplicity of other fibres to produce the web, this being evident to the skilled person without any need for inventive activity. Use is made more particularly of wear-resistant polymers such as polyesters, polyolefins or polyamides or fibres of glass or of carbon.

Also suitable as backing material are backings made of paper (creped and/or uncreped), of a laminate, of a film (for example polyethylene, polypropylene or monoaxially or biaxially oriented polypropylene films, polyester, PA, PVC and other films) or of foam materials in web form (made of polyethylene and polyurethane, for example).

On the coating side it is possible for the surfaces of the backings to have been chemically or physically pretreated, and also for their reverse side to have undergone an anti-adhesive physical treatment or coating.

Finally, the weblike backing material may be a double-sidedly anti-adhesively coated material such as a release paper or a release film, also called a liner.

The following test methods are employed in order to determine the stated measurement values, in the examples as well.

### Test Methods

### Determination of Surface Roughness

The PRIMOS system consists of an illumination unit and a recording unit.

The illumination unit, with the aid of a digital micromirror projector, projects lines onto the surface. These projected parallel lines are diverted or modulated by the surface structure.

The modulated lines are recorded using a CCD camera arranged at a defined angle, referred to as the triangulation angle.

Size of measuring field: 14.5×23.4 mm²

Profile length: 20.0 mm

Areal roughness: 1.0 mm from the edge (Xm=21.4 mm; Ym=12.5 mm)

Filtering: 3rd order polynomial filter

Measuring instruments of this kind can be purchased from companies including GFMesstechnik GmbH at Teltow.

### Peel Strength (Bond Strength)

The peel strength (bond strength) was tested in a method based on PSTC-1.

A strip of the (self-)adhesive tape under investigation is adhered in a defined width (standard: 20 mm) to a ground steel plate or to another desired adhesion/test substrate such as, for example, polyethylene or polycarbonate, etc., by rolling over it ten times using a 5 kg steel roller. Double-sided adhesive tapes are reinforced on the reverse side with an unplasticized PVC film 36 μm thick. Thus prepared, the plate is clamped into the testing instrument, the adhesive strip is peeled from its free end on a tensile testing machine at a peel angle of 180° and at a speed of 300 mm/min, and the force needed to accomplish this is measured. The results are reported in N/cm and are averaged over three measurements. All measurements are conducted in a controlled-climate room at 23° C. and 50% relative humidity.

### Quantitative Determination of Shear Strength: Static Shear Test HP

An adhesive tape is applied to a defined, rigid adhesion substrate (in this case steel) and subjected to a constant shearing load. The holding time in minutes is measured.

A suitable plate suspension system (angle 179±1°) ensures that the adhesive tape does not peel from the bottom edge of the plate.

The test is intended primarily to yield information on the cohesiveness of the composition. This is only the case, however, when the weight and temperature parameters are chosen such that cohesive failure does in fact occur during the test.

Otherwise, the test provides information on the adhesion to the substrate or on a combination of adhesion and cohesiveness of the composition.

A strip, 13 mm wide, of the adhesive tape under test is adhered to a polished steel plaque (test substrate) over a length of 5 cm by rolling over it ten times using a 2 kg roller. Double-sided adhesive tapes are lined on the reverse side with a 50 μm aluminium foil and thus reinforced. Subsequently a belt loop is mounted on the bottom end of the adhesive tape. A nut and bolt is then used to fasten an adapter plaque to the facing side of the shear test plate, in order to ensure the specified angle of 179±1°.

The time for development of strength, between roller application and loading, should be between 10 and 15 minutes.

The weights are subsequently hung on smoothly using the belt loop.

An automatic clock counter then determines the point in time at which the test specimens shear off.

### Quantitative Determination of Shear Deformation: Microshear Travel MST

A strip of the adhesive tape 1 cm wide is adhered to a polished steel plaque (test substrate) over a length of 5 cm, by rolling over the tape ten times using a 2 kg roller. Double-sided adhesive tapes are lined on the reverse side with a 50 μm aluminium foil. The test strip is reinforced with a 190 μm PET film and then cut off with a straight edge using a fixing apparatus. The edge of the reinforced test strip projects 1 mm over the edge of the steel plaque. The plaques are equilibrated under test conditions (23° C., 50% relative humidity) but without loading for 15 minutes in the measuring instrument. Subsequently the desired test weight (in this case 50 g) is hung on, so producing a shearing stress parallel to the bond area. A displacement transducer with a resolution in the μm range is used to plot the shear travel as a function of time, in the form of a graph. The shear travel (shearing path) after weight loading for a defined time (in this case: 10 minutes) is reported as the microshear travel pS1.

### Cold Shock Resistance of Double-Sided PSA Tapes

The cold shock resistance test is intended to test the sensitivity of double-sided (d/s) PSA (pressure-sensitive adhesive) tapes towards sudden, dynamic shock stress. The adhesive tape for testing is used to produce a test element comprising a PC plate and an ABS frame.

The double-sided adhesive tape under test is bonded between these two adherends and then loaded with a 6 kg weight for 5 seconds.

The test element produced in this way is stored at the test temperature for at least 5 hours. Subsequently the cooled test elements are dropped on end from a height of 1.5 m onto a defined substrate (aluminium plate). This procedure is repeated three times.

A qualitative evaluation is made by storage at different temperatures until all of the bonded test specimens pass the test/impact without delamination or the like.

### Density

The density of a coated self-adhesive is determined via the ratio of the coatweight to the respective coat thickness:

$$δ = \frac{m}{V} = \frac{MA}{d} [ δ ] = \frac{[ kg ]}{[ {m}^{2} ] \cdot [ m ]} = [ \frac{kg}{{m}^{3}} ]$$

MA=Mass application/coatweight (excluding weight of backing) in [kg/m²]

Coat thickness (excluding thickness of backing) in [m]

Using inventive examples and comparative examples, the invention is elucidated in more detail below, without any intention thereby to restrict the subject matter of the invention.

Comparative examples 1.1. and 1.2. below present the advantages of the foaming of the self-adhesive by the hotmelt process of the invention as compared with foaming from solvent.

The advantages resulting from the process of the invention can be demonstrated very simply on a completed, foamed self-adhesive tape, as shown in the additional Comparative example 2.

For the sake of brevity, in the examples, the term “hotmelt” is equated with the term “hotmelt process”, which is one process of the invention.

### Raw Materials Used

The examples that follow used these raw materials:

TABLE 1
Raw materials used

| Trade name | Raw material/IUPAC | Manufacturer/Supplier |
|---|---|---|
| Kautschuk SVR 3L | Natural rubber (NR) | Kautschukgesellschaft mbH |
| Kraton D-1118 | Styrene-butadiene-styrene block copolymer (SBS) | Kraton Polymers |
| Kraton D-1102 CS | Styrene-butadiene-styrene block copolymer | Kraton Polymers |
| Europrene SOL T 9113 | Styrene-isoprene-styrene block copolymer (SIS) | EniChem Deutschland GmbH |
| Vector 4113 | Styrene-isoprene-styrene block copolymer | Exxon Mobil Chemical Central |
| | | Europe GmbH |
| Kraton D-1165 | Styrene-isoprene-styrene block copolymer | Kraton Polymers |
| Taipol SBS 3202 | Styrene-butadiene-styrene block copolymer | Taiwan Synthetic Rubber Corp. |
| Regalite R 1125 | Hydrocarbon resin | Eastman Chemical |
| Dercolyte A 115 | Poly-α-pinene resin | DRT (Willers & Engel) |
| Piccotac 1100-E | Aliphatic hydrocarbon resin | Eastman Chemical Middelburg B.V. |
| Pentalyn H-E | Pentaerithritol ester of rosin | Eastman Chemical Middelburg B.V. |
| Dertophene T 110 | Terpene-phenolic resin | DRT (Willers & Engel) |
| Ondina G41 | Mineral oil | Deutsche Shell AG |
| Mikrosöhl 40 | Calcium carbonate | Vereinigte Kreidewerke Dammann |
| Zinc oxide | Zinc oxide | Werner & Heubach |
| Irganox 1726 | 2,4-Bis(dodecylthiomethyl)-6-methylphenol | CIBA GEIGY |
| Irganox 1076 | Octadecyl 3-(3,5-di-tert-butyl-4-hydroxyphenyl) | CIBA GEIGY |
| | propionate | |
| n-Butyl acrylate | n-Butyl acrylate | Rohm & Haas |
| Acrylic acid, pure | Acrylic acid | BASF |
| N-tert-butylacrylamide | N-(1,1-Dimethylethyl)-2-propenamide | Linz Chemie |
| 2-Ethylhexyl acrylate | 2-Ethylhexyl acrylate | Brenntag |
| Bisomer HEMA | 2-Hydroxyethyl methacrylate | IMCD Deutschland |
| Methyl acrylate | Methyl acrylate | BASF |
| Maleic anhydride | 2,5-Dihydro-2,5-furandione, MSA | Condea-Huntsman |
| Expancel 051 DU 40 | Microballoons (MB) | Expancel Nobel Industries |

### Comparative Example 1.1

Using natural rubber based solvent compositions as an example, it is apparent that the adhesion of the adhesive is reduced very sharply even with a fraction of just 1% by weight of microballoons.

The solvent compositions based on NR have the following formulas:

TABLE 2
NR formulas from solvent

| | Formula A | B | C | D | E | |
|---|---|---|---|---|---|---|
| Rubber SVR | 50.0 | 49.75 | 49.5 | 49.25 | 49.0 | Solvent |
| Dertophene T110 | 50.0 | 49.75 | 49.5 | 49.25 | 49.0 | |
| Expancel 051 DU 40 | 0.0 | 0.5 | 1.0 | 1.5 | 2.0 | |

The solids content of the composition in benzine is 40% by weight.

5 solvent compositions were produced in accordance with the above formulas, with different microballoon contents, in a Z-type kneader.

These adhesives are applied using a doctorblade to a 23 μm PET film, at a constant coatweight of 50 g/m² solids.

The coated-out swatch samples are stored initially in a fume cupboard for 15 minutes in order to allow the major part of the solvent used to evaporate, after which the specimens are dried to constant mass at 70° C. for 15 minutes.

The specimens with expandable microballoons added to them are also exposed to the introduction of temperature in a drying oven at 130° C. for five minutes in order to initiate the foaming of the self-adhesive composition.

Table 3 shows how the technical properties of the adhesive are influenced as the fraction of microballoons goes up.

TABLE 3
adhesive properties of a natural rubber composition from solution

| | | | | | | Microshear travel |
|---|---|---|---|---|---|---|
| | | Microballoon | Density | Bond strength | Bond strength | 10 min of 50 g |
| | | content [%] | [kg/m³] | to steel [N/cm] | loss [%] | loading [μm] |
| | Formula A | 0 | 990 | 4.9 | 0 | 1100 |
| | B | 0.5 | 670 | 2.9 | 40.8 | 400 |
| Solvent | C | 1.0 | 540 | 2.4 | 51.0 | 200 |
| | D | 1.5 | 470 | 1.1 | 77.6 | — |
| | E | 2.0 | 400 | 0.3 | 93.9 | — |

In contrast to the bonding force, the cohesion of the self-adhesive is substantially improved by foaming thereof.

A foamed specimen, under equal temperature conditions and equal loading, exhibits a relatively small, or zero, shear travel after 10 minutes (see “Quantitative determination of shear deformation”).

A drop in bond strength for the unfoamed self-adhesive of 41% is observed even with a low microballoon fraction of 0.5% by weight, and, with foaming with 2% by weight of microballoons, the bond strength to steel falls to 0 N/cm.

### Comparative Example 1.2

Hotmelt formula based on natural rubber:

TABLE 4
NR formulas from Hotmelt

| | Formula F | G | H | I | |
|---|---|---|---|---|---|
| Rubber SVR 3L | 50.0 | 49.25 | 48.5 | 45.0 | Hotmelt |
| Dertophene T110 | 50.0 | 49.25 | 48.5 | 45.0 | |
| Expancel 051 DU 40 | 0.0 | 1.5 | 3.0 | 10.0 | |

4 hotmelt adhesives are produced by the above formula with different microballoon contents (0; 1.5; 3; 10% by weight) by a process of the invention.

| | | |
|---|---|---|
| PWE | Temperature (2 heating zones | 60° C. |
| parameters: | and central spindle) = | |
| | Temperature (die) = | 130° C. |
| | Speed (screws) = | 100 rpm |
| ESE | Temperature (4 heating | 140° C. |
| parameters: | zones) = | |
| | Temperature (die) = | 140° C. |
| | Speed (screw) = | 68 rpm |
| Roll applicator | Temperature (doctor roll) = | 140° C. |
| Parameters: | Temperature (coating roll) = | 120° C. |

Production takes place in a process as described in the disclosure relating to FIG. 1.

The natural rubber and the Dertophene 110 tackifier resin are supplied in granule form to the planetary roller extruder, and compounded. The strand of composition thus homogenized, after exiting the die, is passed on into the feed zone of the single-screw extruder, and at the same time the microballoons are metered in. Besides homogeneous distribution in the polymer matrix, the thermoplastic polymer casings of the microballoons are softened in the single-screw extruder at 140° C. and, on exit from the nozzle and/or pressure compensation, the encapsulated isobutane expands, and, consequently, the microballoons expand.

This composition is subsequently coated at 50 g/m² in the roll applicator onto a 23 μm PET film, and the coated film is lined with release film or release paper and then wound to a bale.

In comparison with the foamed solvent composition having the same base formula (see Tables 2 and 3 above) and with a constant coatweight of 50 g/m² on 23 μm PET, the foamed self-adhesive produced in this way achieves the following technical properties (see Table 5: formulas F-I):

TABLE 5
Technical properties, process comparison

| | | Microballoon | Density | Bond strength | Bond strength | Degree of space |
|---|---|---|---|---|---|---|
| | | content [%] | [kg/m³] | to steel [N/cm] | loss [%] | filling MB [%] |
| Solvent | Formula A | 0 | 990 | 4.9 | 0 | 0.0 |
| | B | 0.5 | 670 | 2.9 | 40.8 | 33.1 |
| | C | 1.0 | 540 | 2.4 | 51.0 | 46.5 |
| | D | 1.5 | 470 | 1.1 | 77.6 | 53.7 |
| | E | 2.0 | 400 | 0.3 | 93.9 | 64.0 |
| Hotmelt | F | 0 | 990 | 5.3 | 0 | 0.0 |
| | G | 1.5 | 480 | 5.2 | 1.9 | 52.7 |
| | H | 3.0 | 360 | 5.1 | 3.8 | 65.1 |
| | I | 10.0 | 200 | 4.0 | 24.5 | 81.6 |

Comparing the specimens D (from solvent with 1.5% by weight and 470 kg/m³) and G (hotmelt with 1.5% by weight and 480 kg/m³) directly with one another, it becomes clear that the loss of bond strength of a foamed solvent composition is 78% already here, and in the case of a foamed hotmelt adhesive is only 2%.

Even after foaming with a high microballoon content of 10% by weight and a resulting density of 200 kg/m³ in a hotmelt self-adhesive tape based on the same composition, the drop in bond strength is low, at 25%.

As the microballoon content increases and the density falls, there is an increase in the degree of space filling of the microballoons in the polymer matrix. The theoretically closest sphere packing is achieved at a degree of space filling of 74%, corresponding in this example to a density of 274 kg/m³. With the process of the invention, foams with a low drop in bond strength can be produced even with densities less than 274 kg/m³.

### COMPARATIVE EXAMPLE

Use of the NR self-adhesives from Comparative example 1.2.

In order to destroy the foamed microballoons in the self-adhesive, the specimens under investigation were pressed under vacuum:

Press parameters:
Temperature: 150° C.
Applied pressing force: 10 kN
Vacuum: −0.9 bar
Pressing time: 90 s

TABLE 6
Demonstration of the process advantages

| | | | | | | Thickness | Density | | Bond strength | Increase in |
|---|---|---|---|---|---|---|---|---|---|---|
| | | MB content | Coatweight | Thickness | Density | [μm] | [kg/m³] | Bond strength | steel [N/cm] | bond strength |
| | Formula | [%] | [g/m²] | [μm] | [kg/m³] | defoamed | defoamed | steel [N/cm] | defoamed | [%] |
| from | A | 0 | 50 | 51 | 990.0 | 50 | 1000.0 | 4.9 | 4.9 | 0.0 |
| solvent | B | 0.5 | 50 | 75 | 670.0 | | | 2.9 | | |
| | C | 1 | 50 | 93 | 540.0 | 51 | 980.4 | 2.4 | 4.8 | 50.0 |
| | D | 1.5 | 50 | 106 | 470.0 | | | 1.1 | | |
| | E | 2.0 | 50 | 125 | 400 | 51 | 980.4 | 0.3 | 4.9 | 93.9 |
| Hotmelt | F | 0 | 50 | 51 | 990 | 51 | 980.4 | 5.3 | 5.3 | 0.0 |
| | G | 1.5 | 50 | 104 | 480.0 | 48 | 1041.7 | 5.2 | 5.1 | −2.0 |
| | H | 3 | 50 | 139 | 360.0 | 50 | 1000.0 | 5.1 | 5.2 | 1.9 |
| | I | 10 | 50 | 250 | 200 | 49 | 1020.4 | 4.0 | 5.2 | 23.1 |

In comparison to foaming from solvent, the foaming of a self-adhesive by means of microballoons by the process of the invention has a much smaller effect on the bond strength. The increase in bond strength obtained after defoaming under pressure and temperature corresponds, in the cases investigated, to the loss of bond strength as a result of the foaming.

The parameters for defoaming are to be chosen such that the resulting adhesive approaches a density corresponding to the density of the adhesive in the unfoamed state.

### Comparative Example 2.1

Solvent composition based on SIS:

TABLE 7
SIS formulas from solvent

| | Formula | | | | |
|---|---|---|---|---|---|
| | A | B | C | D | |
| Eurprene Sol T 9113 | 50 | 49 | 47.5 | 46 | Solvent |
| Regalite R 1125 | 44 | 43 | 41.5 | 40 | |
| Ondina G 41 | 5.5 | 5.5 | 5.5 | 5.5 | |
| Irganox 1726 | 0.5 | 0.5 | 0.5 | 0.5 | |
| Expancel 051 DU 40 | 0 | 2 | 5 | 8 | |

Solids content: 40% by weight
Solvent mixture: 67.5% by weight benzine/22.5% by weight acetone/10% by weight toluene

### Processing

Addition of all of the abovementioned raw materials to the solvent mixture of benzine, acetone and toluene, and subsequent thorough mixing at room temperature on a roller bed for approximately 10 hours.

The composition thus produced is then applied to a backing in weblike fashion using a doctorblade, the backing in this example being a 23 μm thick PET film, and application taking place at a constant coatweight of approximately 50 g/m².

The addition and mixing of the microballoons take place immediately prior to the coating-out of the respective composition.

The manufactured specimens are stored, following application of the composition at room temperature, for 15 minutes at room temperature in order to allow the majority of the solvent mixture to evaporate, and then are dried to constant weight in a forced-air drying oven at 70° C. for 15 minutes.

The specimens to which expandable microballoons have been added are additionally exposed to the introduction of temperature in a drying oven at 130° C. for 5 minutes, in order to initiate the foaming of the self-adhesive composition.

The introduction of temperature and the resultant expansion of the microballoons produce a rough surface. Accordingly, a low bond area is achieved on the substrate, such as steel for example, and only low bond strengths, approaching 0 N/cm, are achieved for foamed self-adhesives from solvent.

TABLE 8
Adhesive properties of a foamed solvent composition based on SIS

| | MB content | Coatweight | Thickness | Density | Bond strength | Loss of bond |
|---|---|---|---|---|---|---|
| | [%] | [g/m²] | [μm] | [kg/m³] | steel [N/cm] | strength [%] |
| | 0 | 51.3 | 51 | 1005.9 | 9.1 | 0 |
| from | 2 | 50.6 | 87 | 581.6 | 0 | 100 |
| solvent | | | | | | |
| | 5 | 52.4 | 136 | 385.3 | 0 | 100 |
| | 8 | 49.5 | 160 | 309.4 | 0 | 100 |

Here again, using the example of a solvent composition based on synthetic rubber (styrene-isoprene-styrene block copolymer), it is evident that there is no longer any bond strength at a microballoon fraction of just 2% by weight.

### Comparative Example 2.2

Hotmelt composition based on SIS:

TABLE 9
SIS formulas from hotmelt

| | Formula | | | | |
|---|---|---|---|---|---|
| | A | B | C | D | |
| Eurprene Sol T 9113 | 50 | 49 | 47.5 | 46 | Hotmelt |
| Regalite R 1125 | 44 | 43 | 41.5 | 40 | |
| Ondina G 41 | 5.5 | 5.5 | 5.5 | 5.5 | |
| lrganox 1726 | 0.5 | 0.5 | 0.5 | 0.5 | |
| Expancel 051 DU 40 | 0 | 2 | 5 | 8 | |

Production takes place in a process as described in the disclosure relating to FIG. 1.

Comparison of the technical properties for the same composition formula but different production process (from solvent and from hotmelt by the process of the invention):

TABLE 10
Technical properties, process comparison

| | MB content | Coatweight | Thickness | Density | Bond strength of | Loss of bond |
|---|---|---|---|---|---|---|
| | [%] | [g/m²] | [μm] | [kg/m³] | steel [N/cm] | strength [%] |
| from | 0 | 51.3 | 51 | 1005.9 | 9.1 | 0 |
| solvent | 2 | 50.6 | 87 | 581.6 | 0 | 100 |
| | 5 | 52.4 | 136 | 385.3 | 0 | 100 |
| | 8 | 49.5 | 160 | 309.4 | 0 | 100 |
| Hotmelt | 0 | 48.2 | 48 | 1004.2 | 9.2 | 0 |
| | 2 | 45.0 | 76 | 592.1 | 12.4 | −34.8 |
| | 5 | 49.8 | 110 | 452.7 | 10.1 | −9.8 |
| | 8 | 45.3 | 139 | 325.9 | 9.8 | −6.5 |

In comparison to the unfoamed specimen without microballoons from hotmelt, the foaming by a process of the invention achieves an increase in bond strength for constant coatweight.

### Comparative Example 3

Composition formulas based on SBS, in each case % by weight:

TABLE 11
Composition formulas based on SBS

| | | Formula | | |
|---|---|---|---|---|
| | | A | B | C |
| Kraton D-1118 | [%] | 25 | 22.75 | 23.5 |
| Kraton D-1102 | [%] | 25 | 22.75 | 23.5 |
| Dercolyte A115 | [%] | 49 | 45.5 | 47 |
| Expancel 051 DU 40 | [%] | 0 | 8 | 5 |
| lrganox 1076 | [%] | 1 | 1 | 1 |

Production takes place in a process as described in the disclosure relating to FIG. 1.

TABLE 12
Technical and performance properties of a synthetic rubber composition

| | unfoamed | | foamed | |
|---|---|---|---|---|
| Formula | A | A | B | C |
| CW [g/m²] | 113 | 330 | 119 | 310 |
| Thickness [μm] | 95 | 278 | 350 | 590 |
| Density [kg/m³] | 1189 | 1187 | 340 | 525 |
| BSS 90° [N/cm] | 10.7 | 22.1 | 14.2 | 19.2 |
| Cold shock resistance [° C.] | +10 | +10 | −10 | −10 |

As a result of the foaming of the self-adhesive composition there is virtually no loss of bond strength. The low-temperature shock resistance is substantially improved as a result of the foaming.

### Comparative Example 4

Use of the SIS self-adhesives from Comparative example 2.1. (from solvent) and 2.2. (from hotmelt).

In order to destroy the foamed microballoons in the self-adhesive, the specimens under investigation were pressed under vacuum:

Press parameters:
Temperature: 150° C.
Applied pressing force: 10 kN
Vacuum: −0.9 bar
Pressing time: 90 s

TABLE 13
Demonstration of the process advantages

| | | | | | Thickness | Density | | Bond strength | |
|---|---|---|---|---|---|---|---|---|---|
| | MB content | Coatweight | Thickness | Density | [μm] | [kg/m³] | Bond strength | of steel [N/cm] | Loss of bond |
| | [%] | [g/m²] | μm | [kg/m³] | After press | After press | of steel [N/cm] | After press | strength [%] |
| from | 0 | 51.3 | 51 | 1005.9 | 52 | 986.5 | 9.1 | 8.9 | −2.2 |
| solvent | 2 | 50.6 | 87 | 581.6 | 52 | 973.1 | 0 | 8.1 | 100.0 |
| | 5 | 52.4 | 136 | 385.3 | === | === | 0 | — | — |
| | 8 | 49.5 | 160 | 309.4 | === | === | 0 | — | — |
| Hotmelt | 0 | 48.2 | 48 | 1004.2 | 51 | 945.1 | 9.2 | 9.1 | −1.1 |
| | 2 | 47.3 | 78 | 606.4 | 48 | 985.4 | 12.4 | 9.0 | −37.8 |
| | 5 | 49.8 | 110 | 452.7 | 52 | 957.7 | 10.1 | 9.4 | −7.4 |
| | 8 | 47.8 | 140 | 341.43 | 49 | 975.5 | 9.8 | 9.1 | −7.7 |

The foaming of a self-adhesive composition by means of microballoons thus has no adverse effect on the bond strength. In comparison to the respective unfoamed composition, indeed, the bond strength actually rises with this composition system. This can be explained as a result of the better wetting behaviour of a foam on the substrate, and the greater thickness of the foamed specimens as compared with respective defoamed specimens.

### Inventive Example 5

Composition formula based on natural rubber:

| Rubber SVR 3L | 47.5% by weight | |
|---|---|---|
| Piccotac 1100-E | 47.5% by weight | |
| Expancel 051 DU 40 | 5.0% by weight | |
| PWE parameters: | Temperature (2 heating zones) = | 50° C. |
| | Temperature (central spindle) = | 10° C. |
| | Temperature (die) = | 160° C. |
| | Speed (screws) = | 25 rpm |
| ESE parameters: | Temperature (heating zone 1) = | 20° C. |
| | Temperature (heating zone 2) = | 60° C. |
| | Temperature (heating zone 3) = | 100° C. |
| | Temperature (heating zone 4) = | 140° C. |
| | Temperature (die) = | 140° C. |
| | Speed (screw) = | 62 rpm |
| Roll applicator | Temperature (doctor roll) = | 130° C. |
| parameters: | Temperature (coating roll) = | 130° C. |

Production takes place in a process as described in the disclosure relating to FIG. 1. The natural rubber and the Piccotac 1100-E resin are supplied in granule form to the planetary roller extruder, and compounded. The strand of composition thus homogenized, after exiting the die, is passed on into the feed zone of the single-screw extruder, and at the same time the microballoons are metered in. Besides homogeneous distribution in the polymer matrix, the thermoplastic polymer casings of the microbeads are softened in the single-screw extruder at 140° C. and, on exit from the die and/or pressure compensation, the encapsulated isobutane expands, and, consequently, the microballoons expand. Subsequently this composition is coated onto a woven fabric backing in the roll applicator, and wound to a bale.

This foamed self-adhesive composition achieves the following technical properties:

TABLE 14
Technical properties of a single-sided natural-rubber adhesive tape
Foamed single-sided NR adhesive tape

| Coatweight | [g/m²] | 106 |
|---|---|---|
| Total thickness | [μm] | 415 |
| Density | [kg/m³] | 320 |
| Bond strength to steel | [N/cm] | 2.6 |
| 180° | | |
| Bond strength to PE | [N/cm] | 1.7 |

180°

### Inventive Example 6

Composition formulas based on natural rubber:

| | A (unfoamed) | B (foamed) |
|---|---|---|
| Rubber SVR 3L | 49.5% by weight | 48.35% by weight |
| Piccotac 1100-E | 49.5% by weight | 48.35% by weight |
| Expancel 051 DU 40 | | 2.3% by weight |
| Irganox 1076 | 1.0% by weight | 1.0% by weight |
| PWE parameters: | Temperature (2 heating zones) = | 50° C. |
| | Temperature (central spindle) = | 10° C. |
| | Temperature (die) = | 160° C. |
| | Speed (screws) = | 50 rpm |
| ESE parameters: | Temperature (heating zone 1) = | 20° C. |
| | Temperature (heating zone 2) = | 60° C. |
| | Temperature (heating zone 3) = | 100° C. |
| | Temperature (heating zone 4) = | 140° C. |
| | Temperature (die) = | 140° C. |
| | Speed (screw) = | 68 rpm |
| Roll applicator | Temperature (doctor roll) = | 130° C. |
| parameters: | Temperature (coating roll) = | 130° C. |

Production takes place in a process as described in the disclosure relating to FIG. 1. The natural rubber and the Piccotac 1100-E resin are supplied in granule form to the planetary roller extruder, and compounded. The strand of composition thus homogenized, after exiting the die, is passed on into the feed zone of the single-screw extruder, and at the same time, in formula B, the microballoons are metered in. Besides homogeneous distribution in the polymer matrix, the thermoplastic polymer casings of the microbeads are softened in the single-screw extruder at 140° C. and, on exit from the die and/or pressure compensation, the encapsulated isobutane expands, and, consequently, the microballoons expand.

Not only the foamed but also the unfoamed natural rubber composition was coated onto a creped paper backing with reverse-side release, and then a comparison of technical properties was made between these systems. It is notable that 25 g/m² of composition can be saved for approximately the same coat thickness, with at the same time a similar technical level to an unfoamed NR composition.

TABLE 15
Technical properties

| | | A | B |
|---|---|---|---|
| Coatweight | [g/m²] | 50 | 25 |
| Total thickness | [μm] | 144 | 138 |
| Density | [kg/m³] | 950 | 590 |
| Bond strength to steel | [N/cm] | 2.7 | 2.3 |
| 180° C. | | | |
| Surface roughness Ra | μm | 8.6 | 7.7 |

This example demonstrates that with the process of the invention it is possible to produce self-adhesive products which have a low loss of bond strength despite the fact that the thickness of the coat of composition corresponds to the diameter of the expanded microballoons.

### Inventive Example 7

Composition formula based on SIS:

| Vector 4113 | 47.5% by weight | |
|---|---|---|
| Pentalyn H-E | 47.5% by weight | |
| Expancel 051 DU 40 | 5.0% by weight | |
| PWE parameters: | Temperature (2 heating zones | 80° C. |
| | and central spindle) = | |
| | Temperature (die) = | 130° C. |
| | Speed (screws) = | 50 rpm |
| Roll applicator | Temperature (doctor roll) = | 140° C. |
| parameters: | Temperature (coating roll) = | 130° C. |

Production takes place in a particularly advantageous process of the kind described in the disclosure relating to FIG. 3.

The styrene block copolymer vector 4113, the resin Pentalyn H-E, and the Expancel 051 DU 40 microballoons are supplied to the planetary roller extruder. Besides the compounding of the polymer matrix and the homogeneous distribution of the microballoons in the said matrix, the thermoplastic polymer casings of the microballoons are softened in the extruder at 140° C. and, on exit from the die or pressure compensation, the encapsulated isobutane expands and, consequently, the microballoons expand. Subsequently this composition is coated onto a woven fabric backing in the roll applicator, and then wound to a bale.

This foamed self-adhesive composition achieves the following technical properties:

TABLE 16
Technical properties of a single-sided SIS self-adhesive tape

| | | A | B |
|---|---|---|---|
| Coatweight | [g/m²] | 135 | 40 |
| Total thickness | [μm] | 430 | 175 |
| Density | [kg/m³] | 420 | 420 |
| Bond strength to steel 180° | [N/cm] | 13.6 | 8.9 |
| Bond strength to PE 180° | [N/cm] | 2.8 | 2.3 |
| HP RT 10N | [min] | >10 000 | >10 000 |

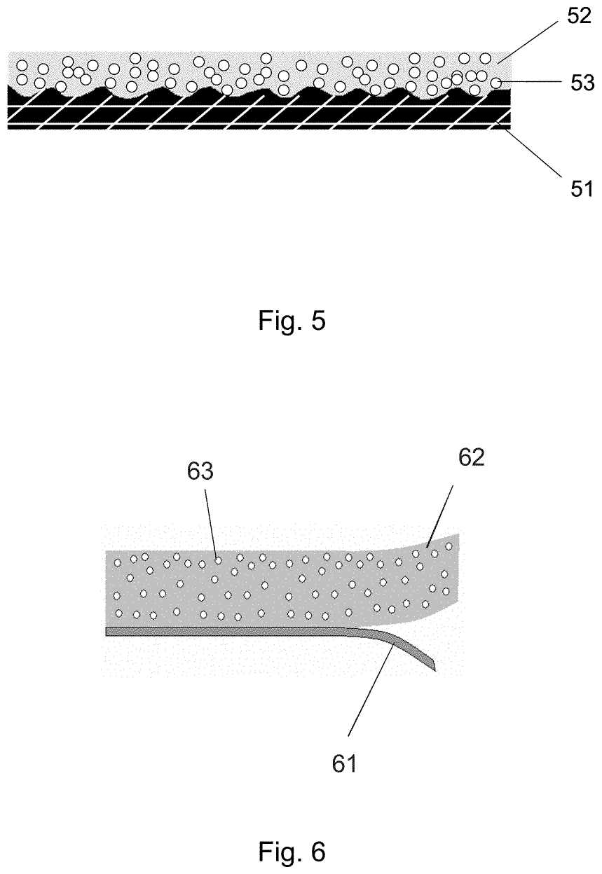

FIG. 5 shows the construction of a self-adhesive tape foamed with microballoons 53 and consisting of an adhesive 52, containing the microballoons 53, on a woven fabric backing 51.

Despite high levels of microballoons and low density, with this invention, the technical properties of the foamed self-adhesive compositions are situated at the same level as those of the unfoamed adhesive.

Inventive examples 6 and 7 demonstrate the outstanding suitability of the foamed adhesives of the invention for compensating the roughness or structure of backings.

### Inventive Example 8

Composition formula based on SIS:

| Vector 4113 | 47.5% by weight | |
|---|---|---|
| Pentalyn H-E | 47.5% by weight | |
| Expancel 051 DU 40 | 5.0% by weight | |
| PWE parameters: | Temperature (2 heating zones | 60° C. |
| | and central spindle) = | |
| | Temperature (die) = | 130° C. |
| | Speed (screws) = | 100 rpm |
| ESE parameters: | Temperature (4 heating zones) = | 140° C. |
| | Temperature (die) = | 140° C. |
| | Speed (screw) = | 68 rpm |
| Roll applicator | Temperature (doctor roll) = | 140° C. |
| parameters: | Temperature (coating roll) = | 140° C. |

Production takes place in a process of the kind described in the disclosure relating to FIG. 1.

The vector 4113 styrene block copolymer and the Pentalyn H-E resin are supplied in granule form to the planetary roller extruder, and compounded. The strand of composition thus homogenized, after exiting the die, is passed on into the feed zone of the single-screw extruder, and at the same time the microballoons are metered in. Besides homogeneous distribution in the polymer matrix, the thermoplastic polymer casings of the microbeads are softened in the single-screw extruder at 140° C. and, on exit from the die and/or pressure compensation, the encapsulated isobutane expands, and, consequently, the microballoons expand.

Subsequently this composition is coated in a roll applicator onto the low-siliconized side of an 80 μm release paper (double-sidedly siliconized, different release forces: coating side=95 cN/cm and release side=13 cN/cm), and the coated release system is then wound.

This double-sided self-adhesive foam fixer attains the following technical properties:

TABLE 17
Technical properties of an SIS foam fixer
Double-sided adhesive SIS foam fixer

| | | |
|---|---|---|
| Coatweight | [g/m²] | 160 |
| Thickness | [μm] | 340 |
| Density | [kg/m³] | 470 |
| Bond strength to steel | [N/cm] | 21.8 |
| 90° open side | | |
| Bond strength to PE | [N/cm] | 12.5 |
| 90° open side | | |
| HP RT 10N | [min] | 12 600 |
| open side | | |

### Inventive Example 9

Composition formula based on SBS/SIS:

| Kraton D-1165 | 23.0% by weight | |
|---|---|---|
| Taipol SBS 3202 | 23.0% by weight | |
| Dercolyte A115 | 46.0% by weight | |
| Expancel 051 DU 40 | 8.0% by weight | |
| PWE parameters: | Temperature (2 heating zones | 130° C. |
| | and central spindle) = | |
| | Temperature (die) = | 160° C. |
| | Speed (screws) = | 100 rpm |
| ESE parameters: | Temperature (4 heating zones) = | 50° C. |
| | Temperature (die) = | 50° C. |
| | Speed (screw) = | 68 rpm |
| Roll applicator | Temperature (doctor roll) = | 140° C. |
| parameters: | Temperature (coating roll) = | 140° C. |

Production takes place in a process of the kind described in the disclosure relating to FIG. 1.

The Kraton D-1165, Taipol SBS 3202 and Dercolyte A115 are supplied in corresponding amount in granule form to the planetary roller extruder, and compounded. The strand of composition thus homogenized, after exiting the die, is passed on into the feed zone of the single-screw extruder, and at the same time the microballoons are metered in. Besides homogeneous distribution in the polymer matrix, the thermoplastic polymer casings of the microbeads are softened in the single-screw extruder at 140° C. (as a result of the residual heat in the composition from the PWE) and, on exit from the die and/or pressure compensation, the encapsulated isobutane expands, and, consequently, the microballoons expand.

Subsequently this composition is coated in a roll applicator onto the low-siliconized side of an 80 μm release paper (double-sidedly siliconized; different release forces: 95 and 13 cN/cm), and the coated release system is then wound.

This double-sided self-adhesive foam fixer attains the following technical properties:

TABLE 18
Technical properties of an SBS/SIS foam fixer
Double-sided adhesive SBS foam fixer

| | | |
|---|---|---|
| Coatweight | [g/m²] | 300 |
| Thickness | [μm] | 850 |
| Density | [kg/m³] | 350 |
| Bond strength to steel | [N/cm] | 17.0 |
| 90° open side | | |
| Bond strength to PE | [N/cm] | 13.0 |
| 90° open side | | |
| SSZ RT 10N | [min] | >10 000 |
| open side | | |

FIG. 6 shows the construction of an adhesive 62, foamed with microballoons 63, which has been applied to a liner 61.

### Inventive Example 10

Composition formulas based on acrylate copolymers:

Ac Composition A:

| | |
|---|---|
| n-Butyl acrylate | 44.2% by weight |
| 2-Ethylhexyl acrylate | 44.7% by weight |
| Methyl acrylate | 8.6% by weight |
| Acrylic acid, pure | 1.5% by weight |
| Bisomer HEMA | 1.0% by weight |

Ac Composition B:

| | |
|---|---|
| n-Butyl acrylate | 44.9% by weight |
| 2-Ethylhexyl acrylate | 44.9% by weight |
| N-tert-Butylacrylamide | 6.2% by weight |
| Acrylic acid, pure | 3.0% by weight |
| Maleic anhydride | 1.0% by weight |

Both acrylate compositions, A and B, are blended with 5% and 8% of microballoons in each case:

The above monomer mixtures (quantities in % by weight) are copolymerized in solution. The polymerization batches are composed of 60% by weight of the monomer mixtures and 40% by weight of solvents (such as benzine 60/95 and acetone). The solutions are first freed from oxygen, by flushing with nitrogen, and then heated to boiling in typical reaction vessels of glass or steel (with reflux condenser, stirrer, temperature measuring unit and gas inlet tube).

The polymerization is initiated by adding 0.2% to 0.4% by weight of an initiator typical for free-radical polymerization, such as dibenzoyl peroxide, dilauroyl peroxide or azobisisobutyronitrile.

During the polymerization time of approximately 20 hours, dilution is carried out where appropriate a number of times with further solvent, depending on viscosity, so that the completed polymer solutions have a solids content of 35% to 55% by weight.

Concentration is accomplished by lowering the pressure and/or raising the temperature.

The production of the self-adhesive composition blended with microballoons takes place in a process as described in the disclosure relating to FIG. 1.

The acrylate composition is supplied in strand form to the continuous mixing assembly, in this case a twin-screw extruder, and at the same time the microballoons are added. Besides homogeneous distribution in the polymer matrix, the thermoplastic polymer casings of the microballoons are softened in the heated twin-screw extruder at 140° C. and, on exit from the nozzle or pressure compensation, the encapsulated isobutene expands and, accordingly, the microballoons expand.

Subsequently this composition is coated onto the low-siliconized side of an 80 μm release paper (double-sidedly siliconized; different release forces: 95 and 13 cN/cm) and the coated release system is then wound up.

The following technical properties were set for the Ac compositions A and B:

TABLE 19
Technical properties of acrylate composition A
Ac composition A

| | | | | Bond strength, |
|---|---|---|---|---|
| MB content | Coatweight | Thickness | Density | steel |
| [%] | [g/m²] | [μm] | [kg/m³] | [N/cm] |
| 0 | 520 | 510 | 1020 | 20.1 |
| 5 | 260 | 491 | 530 | 15.8 |
| 8 | 170 | 459 | 370 | 12.3 |

TABLE 20
Technical properties of acrylate composition B
Ac composition B

| | | | | Bond strength |
|---|---|---|---|---|
| MB content | Coatweight | Thickness | Density | steel |
| [%] | [g/m²] | [μm] | [kg/m³] | [N/cm] |
| 0 | 530 | 505 | 1050 | 12.5 |
| 5 | 250 | 424 | 590 | 9.2 |
| 8 | 200 | 500 | 400 | 8.1 |

As a result of the foaming of the acrylate composition, even with a lower coatweight and similar coat thickness, there is virtually no loss of bond strength found.

In order to increase the thermal shear strength, these composition systems can be outstandingly crosslinked either by means of ionizing radiation or by means of crosslinking systems known from the literature, such as isocyanates, epoxides or phenolic resins, for example.

1. Pressure-sensitive adhesive comprising an adhesive base and a plurality of expanded microballoons, wherein:
the pressure-sensitive adhesive has a bond strength;
the bond strength is reduced by not more than 30% compared to a bond strength of a comparable pressure-sensitive adhesive in which voids formed by a plurality of expanded microballoons are destroyed but which is otherwise identical to the pressure-sensitive adhesive;
the pressure-sensitive adhesive has a surface roughness of less than or equal to 10 μm; and
the adhesive base comprises randomly copolymerized styrene-butadiene rubber, a styrene block copolymers, or a compound comprising randomly copolymerized styrene-butadiene rubber and a styrene block copolymers.

2. Pressure-sensitive adhesive comprising an adhesive base and a plurality of expanded microballoons, wherein:
the pressure-sensitive adhesive has a bond strength;
the bond strength is not reduced compared to a bond strength of a comparable pressure-sensitive adhesive in which voids formed by a plurality of expanded microballoons are destroyed but which is otherwise identical to the pressure-sensitive adhesive;
the pressure-sensitive adhesive has a surface roughness of less than or equal to 10 μm; and
the adhesive base comprises randomly copolymerized styrene-butadiene rubber, a styrene block copolymer, or a compound comprising randomly copolymerized styrene-butadiene rubber and a styrene block copolymers.

3. Pressure-sensitive adhesive comprising an adhesive base and a plurality of expanded microballoons, wherein:
the pressure-sensitive adhesive has a bond strength;
the bond strength is increased compared to a bond strength of a comparable pressure-sensitive adhesive in which voids formed by a plurality of expanded microballoons are destroyed but which is otherwise identical to the pressure-sensitive adhesive;
the pressure-sensitive adhesive has a surface roughness of less than or equal to 10 μm; and
the adhesive base comprises randomly copolymerized styrene-butadiene rubber, a styrene block copolymer, or a compound comprising randomly copolymerized styrene-butadiene rubber and a styrene block copolymer.

4. (canceled)

5. Adhesive according to claim 1, wherein the plurality of expanded microballoons is present at between at least 0% and 20% by weight of the pressure-sensitive adhesive.

6. Adhesive according to claim 1, wherein:
the pressure-sensitive adhesive has a density;
the comparable pressure-sensitive adhesive has a density; and
the density of the pressure-sensitive adhesive is less than 80% of the density of the comparable pressure-sensitive adhesive.

7. Adhesive according to claim 1, wherein the pressure-sensitive adhesive further comprises an aging inhibitor, a crosslinker, a light stabilizer, an ozone protectant, a fatty acid, a resin, a plasticizer, a vulcanizing agent, an electron-beam curing promoters, an ultraviolet initiator, or a filler.

8. Adhesive according to claim 1, wherein the pressure-sensitive adhesive is crosslinked.

9. Adhesive according to claim 1, wherein each expanded microballoon of the plurality of expanded microballoons has a diameter of 20 μm to 200 μm.

10. Adhesive according to claim 1, wherein the bond strength is reduced by not more than 20%.

11. Adhesive according to claim 1, wherein the bond strength is reduced by not more than 10%.

12. Adhesive according to claim 3, wherein the bond strength is increased by 10% to 30% compared to a bond strength of a comparable pressure-sensitive adhesive in which voids formed by a plurality of expanded microballoons are destroyed but which is otherwise identical to the pressure-sensitive adhesive.

13. Adhesive according to claim 5, wherein the plurality of expanded microballoons is present at between 1.5% and 10% by weight of the pressure-sensitive adhesive.

14. Adhesive according to claim 7, wherein the filler comprises carbon black, zinc oxide, silica, silicates, chalk beads, solid beads, or hollow beads.

15. Adhesive according to claim 9, wherein each expanded microballoon of the plurality of expanded microballoons has a diameter of 40 μm to 100 μm.

16. Adhesive according to claim 1, wherein the styrene block copolymer comprises a styrene-isoprene-styrene block copolymer.

17. Adhesive according to claim 1, wherein the pressure-sensitive adhesive further comprises an aging inhibitor.

18. Adhesive according to claim 1, wherein the pressure-sensitive adhesive further comprises a light stabilizer.

19. Adhesive according to claim 1, wherein the pressure-sensitive adhesive further comprises silica.

20. Adhesive according to claim 1, wherein the pressure-sensitive adhesive is shaped to a layer by shaping assembly.

21. Adhesive according to claim 1, wherein the pressure-sensitive adhesive is shaped to a layer by a calender, a roll applicator, or a nip formed by a roll and a stationary doctor blade.

22. Adhesive according to claim 1, wherein:
the pressure-sensitive adhesive is shaped to a layer by a shaping assembly;
the pressure-sensitive adhesive further comprises a polymer matrix; and
the expanded microballoons are pressed back into the polymer matrix.
